(19) United States
(12) Patent Application Publication
(10) Pub. No.: US 2008/0173639 A1
(43) Pub. Date: Jul. 24, 2008

(54) Plastic container for food

(76) Inventor: Jo Vos, Antwerpen (BE)

Correspondence Address: SHLESINGER, ARKWRIGHT & GARVEY LLP, 1420 KING STREET, SUITE 600, ALEXANDRIA, VA, 22314, US

(21) Appl. No.: 11/907,113

(22) Filed: Oct. 9, 2007

Related U.S. Application Data
(63) Continuation of application No. PCT/EP2006/003374, filed on Apr. 12, 2006.
Application No. PCT/EP2006/003374 is a continuation of application No. PCT/EP2005/003871, filed on Apr. 13, 2005.

(51) Int. Cl. H05B 6/12

(52) U.S. Cl. 219/621

(57) ABSTRACT

Plastic container for food includes a base body. The material from which said base body is manufactured includes a plastic or plastic into which electrically conductive particles are embedded for obtaining electrical conductivity of the material for induction heating of food received in the container, in use.

### CROSS-REFERENCE TO RELATED APPLICATIONS

This application is a continuation of application no. PCT/EP2006/003374, filed Apr. 12, 2006, which claims the priority of PCT application no. PCT/EP2005/003871, filed Apr. 13, 2005, and each of which is incorporated herein by reference.

### FIELD OF THE INVENTION

The invention relates to a plastic(s) container for food. Further, the invention relates to a plastic(s) container for food including a base body made of a material including a plastic.

### BACKGROUND OF THE INVENTION

Plastic containers of this kind are well-known and are used for catering in general and in particular for catering purposes on board aircrafts.

In case that warm food, e. g. a warm lunch or dinner, is to be served e. g. on board of an aircraft, a container manufactured from aluminium foil or the like is used in which the food is received. For heating the food the container is placed in a hot-air oven which is provided at galley of the aircraft. After a sufficient heating time, the container is taken out of the oven and is served to a passenger.

With the known container, heating the food is relatively complicated and time-consuming since it is necessary to insert the container into the hot-air oven. Furthermore, a large amount of waste is produced since the known containers made from aluminium foil or the like have to be disposed after use.

### OBJECTS AND SUMMARY OF THE INVENTION

It is an object of the invention to provide a plastic container for food which simplifies the serving of warm food in particular on board aircrafts and by means of which the amount of waste produced in connection with serving warm food may be reduced.

This object is achieved by the invention which includes a plastic container for food. The plastic container for food includes a base body made of a material, and the material of the base body includes a plastic. Electrically conductive particles are provided that are configured and embedded in the plastic for obtaining electrical conductivity of the material of the base body for induction-heating of food received in the container, in use.

The invention is based on the idea to replace the time-consuming and rather complicated hot-air heating of food in particular on board aircrafts by induction-heating. The heating equipment for induction heating generally consists of an induction coil. In use, the induction coil is fed by an alternating current such that the coil generates a magnetic field. If an electrically conductive material is placed in the magnetic field generated by the coil, the magnetic field will generate eddy currents in the conductive material. The flow of these currents will generate resistive heating inside the electrically conductive material.

In order to enable induction-heating of food received in a container manufactured from plastic, according to the invention the base body of the plastic container at least partially is provided with an electrically conductive material. In particular, the material from which the base body is manufactured includes plastic into which electrically conductive particles are embedded for obtaining electrical conductivity of the material for induction-heating of food received in the container.

Consequently, using the plastic container according to the invention, food received in the container may be heated using induction-heating. Accordingly, it is no longer necessary to heat the food in a hot-air oven. Consequently, the heating equipment required for heating the food is simplified in a substantial manner. Furthermore, induction-heating of the food as proposed by the invention is faster and more economical than hot-air heating in a hot-air oven.

The size, shape, extent, and amount of particles embedded into the plastic may be varied within wide ranges as long as an electrical conductivity is obained which is sufficient for heating of food received in the container. As a further advantage of the invention, the plastic container according to the invention may be reusable and does not necessarily have to be disposed after use as it is the case for the known containers made from aluminium foil or the like. Consequently, the amount of waste produced in connection with serving warm food on board aircrafts may be reduced in a substantial manner. Accordingly, the invention is very environmentally friendly.

Furthermore, the plastic container according to the invention may be manufactured at very low costs. Generally, the plastic used for manufacturing the container according to the invention will be heat-resistant up to temperatures which are reached during heating the food and will have a good thermal conductivity. Furthermore, the plastic will be food-approved and preferably will be formable by injection-molding or thermo-forming.

According to the invention, the provision of an electrically conductive material on or in the base body of the container may be varied within wide ranges according to the respective requirements.

In a preferred embodiment, said electrically conductive particles are included in at least one side and/or bottom wall of said base body. In this embodiment, the required heat is generated in the area of the side and/or bottom walls of the base body which are in contact with the food to be heated.

Basically, according to the invention the base body may be manufactured from an electrically insulating plastic or a plastic which has a very poor electrical conductivity, said plastic being provided with an electrically conductive material for obtaining an overall electrical conductivity which is sufficient for induction-heating of food received in the container.

Preferably, said particles include fibers. Appropriate fibers are available with a sufficient electrical conductivity at very low costs. By varying the amount of fibers embedded into the plastic, the electrical conductivity obtained by embedding the fibers into the plastic may be varied within wide ranges.

In the aforementioned embodiment, it is preferred that said fibers include metal fibers. Appropriate metal fibers are available at very low costs and have a high electrical conductivity.

In the aforementioned embodiment, any appropriate metal may be used. However, it is preferred that the metal is selected from the group consisting of aluminum and silver.

According to a further preferred embodiment, said fibers are manufactured from a material having a relatively low electrical conductivity which is coated with a material having a relatively high electrical conductivity. In this embodiment, particles with a relatively low electrical conductivity may be used as a carrier for the material having a relatively high electrical conductivity thereby making the surface of the fibers electrically conductive. Consequently, in this embodiment it is not necessary to use fibers which are completely electrically conductive so that in this embodiment the manufacturing costs are reduced.

In the aforementioned embodiment said material having a relatively low electrical conductivity preferably includes carbon. If e. g. the material having a relatively high electrical conductivity is silver, in comparison thereto the electrical conductivity of the carbon is relatively low. However, due to its electrical conductivity the carbon contributes substantially to the electrical conductivity of the plastic when e. g. carbon fibers coated with silver are embedded into the plastic.

In order to obtain sufficient induction-heating of food received in the container it is basically sufficient if only a section of the base body is electrically conductive. Accordingly, in order to reduce the manufacturing costs of the container according to the invention it is preferred that said base body includes at least one electrically conductive section. The electrically conductive section is preferably positioned close to an area which is in contact with the food to be heated such that upon induction-heating of the electrically conductive section the food is heated as desired.

In order to obtain a uniform electrical conductivity and thereby a uniform heating along the electrically conductive section, it is preferred that in at least one electrically conductive section said particles are embedded into said base body in the form of a substantially uniform layer.

The size, shape and amount of particles embedded into the plastic may be varied within wide ranges. According to a preferred embodiment, the size of the particles is approximately 1 to 10 μm. With particles of this size, a very uniform electrical conductivity is obtained. Furthermore, with this size of particles the same do not have any adverse effect upon the forming process of the plastic container, e. g. on an injection-molding process.

As an alternative or in addition to electrically conductive particles embedded into the base body, according to the invention it is possible that said base body is provided with at least one layer or coating including an electrically conductive material. Consequently, according to the invention it is possible to use a plastic which has an inherent electrical conductivity caused by electrically conductive particles embedded into the plastic or to use an electrically-insulating plastic which is provided with a layer or coating which includes an electrically conductive material or a combination of both.

Within the terms of the invention, a material is regarded to be electrically conductive if it has a specific electrical resistance p<10⁻² Ω cm.

According to the invention it is preferred that said layer is located beyond the surface of the base body.

In order to avoid problems caused by a possible lack of food compatibility of the electrically conductive material of the layer or coating, it is preferred that said layer or coating is located on a surface which in use of the container does not come into contact with food received in the container; i.e., which is free of contact with food received in the container, in use. Particularly, the layer or coating may be located on an outer wall of a bottom of the container facing away from the inner wall of the container which is in contact with food received in the container.

According to a preferred embodiment, the electrically conductive material includes metal. In this embodiment, due to the use of metal a high electrical conductivity may be obtained at very low costs.

The electrical conductivity of the material from which the base body is manufactured may be varied within wide ranges as long as a sufficient induction-heating of food received in the container may be obtained. According to a preferred embodiment, the overall electrical conductivity of the material from which said base body is manufactured is at least 1×10⁻⁶ Ωm. In the terms of the invention the overall electrical conductivity is defined as the electrical conductivity of the plastic in combination with the respective electrically conductive material, e. g. in the form of particles embedded into the plastic and/or in the form of an electrically conductive coating or a layer. In this embodiment, a sufficient electrical conductivity is obtained to enable sufficient induction-heating of food received in the container.

It is a further aspect of the invention to use plastic which is at least partially and/or sectionally electrically conductive for manufacturing a plastic container for food as set forth herein.

A preferred embodiment of the use of such plastic which is one of partially and sectionally electrically conductive for manufacturing a plastic container for food includes manufacturing by one of injection molding and thermoforming the plastic.

The invention will now be explained in greater detail with reference to the accompanying drawings wherein all features described in the description or shown in the drawings define the subject matter of the invention, either taken per se or in arbitrary combination, regardless of their combination in the claims or the references of the claims as well as regardless of their description or representation respectively in the specification or in the drawings respectively.

Relative terms such as up, down, left, and right are for convenience only and are not intended to be limiting.

The term plastic is intended to encompass a plastic or plastics.

The term polymer is intended to encompass a natural and/or a synthetic polymer.

### BRIEF DESCRIPTION OF THE DRAWINGS

FIG. 1 is a cross-section of a first embodiment of a plastic container according to the invention including a heating device or equipment,

FIG. 2 is a cross-section of a second embodiment of a plastic container according to the invention including a heating device or equipment,

FIG. 3 is a cross-section of a third embodiment of a plastic container according to the invention including a heating equipment, and

FIG. 4 is a cross-section of a fourth embodiment of a plastic container according to the invention including a heating device or equipment.

### DETAILED DESCRIPTION OF THE INVENTION

Throughout the several representations of the drawings, the same parts are referenced by the same reference numerals.

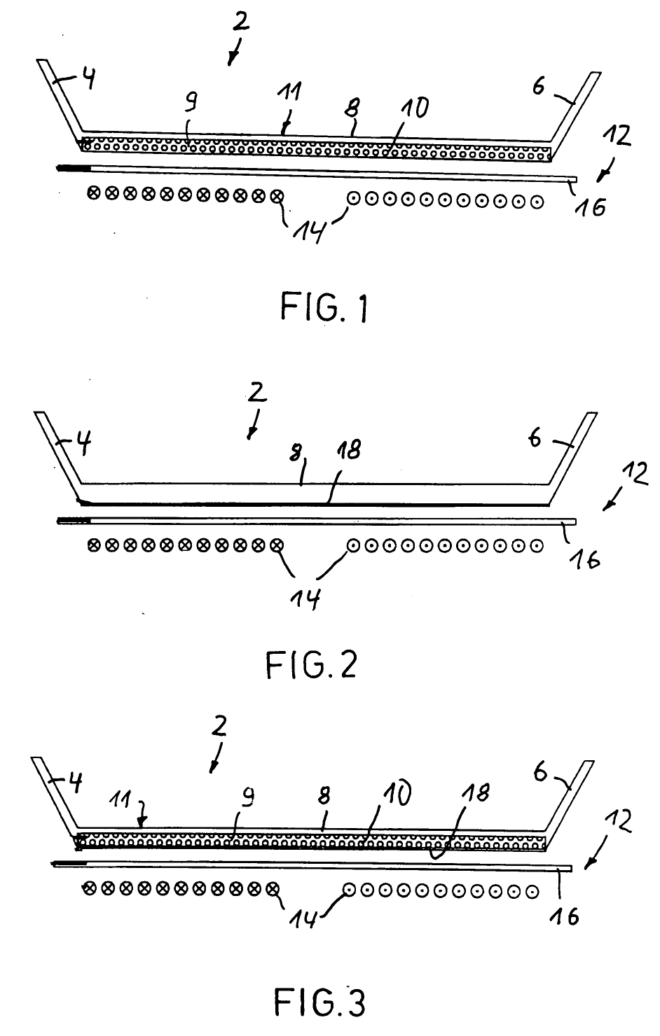

In FIG. 1 a first embodiment of a plastic container 2 for food is shown which includes a base body 4 which is manufactured from plastic. The base body includes a circumferential outer wall 6 and a bottom wall 8. As can be seen from FIG. 1, in the embodiment shown in FIG. 1 the container 2 has the shape of a flat casserole.

According to the invention, for induction-heating of food (not shown) received in the container 2 said base body 4 at least partially is provided with an electrically conductive material which in the embodiment shown in FIG. 1 is included in the bottom wall 8 of the base body 4 as will be explained below in greater detail.

In the embodiment shown in FIG. 1, the bottom wall 8 of the base body 4 is manufactured from an electrically conductive plastic which has an inherent electrical conductivity which is sufficient to allow for induction heating of food received in the container 2. In order to obtain a sufficient inherent electrical conductivity of the plastic, electrically conductive particles 10 shown schematically in FIG. 1 are embedded into the material of the bottom wall 8 of the base body 4. However, according to the invention it is also possible to manufacture the complete base body 4 from a plastic which has an inherent electrical conductivity.

In the embodiment shown in FIG. 1 the plastic from which the base body 4 is manufactured is a polymer into which in the area of the bottom wall 8 which defines an electrically conductive section aluminum fibers are embedded, said aluminum fibers having a size of approximately 1 to 10 μm. The aluminum fibers are embedded into the material of the bottom wall 8 in the form of a substantially uniform layer 9 wherein the amount of aluminum fibers and thus the thickness of the layer 9 is chosen such that in use by induction-heating sufficient heat is generated to heat food received in the container, as will be explained below.

As can be seen in FIG. 1, the upper side of the layer 9 is covered by layer 11 of plastic while the bottom side of the layer 9 is not covered by plastic but forms the outer surface of the bottom of the container 2.

In FIG. 1, a heating device or equipment 12 for induction heating of food received in the container 2 is shown in a very schematic manner. The heating equipment 12 includes an induction coil 14 which in use is separated from the container 2 by a thermal insulation 16.

The heating of food received in the container 2 by means of the heating equipment 12 is performed as follows:

The induction coil 14 is fed by an alternating current of e. g. approximately 30 kHz frequency by a power supply (not shown). This feeding voltage is chosen depending on the power needed. The alternating current generates a magnetic field in which the container 2 is placed. Due to the aluminum fibers 10 embedded into the plastic, the magnetic field generated by the induction coil 14 generates eddy currents in the electrically conductive particles. The flow of these currents generates resistive heating inside the aluminum fibers 10 and thereby in the bottom wall 8 of the base body 4. Consequently, the bottom wall 8 is heated with the heat being transferred to the food which is in contact with the bottom wall 8.

Accordingly, the food received in the container 2 is heated in a very fast end economical manner. During the heating process, the plastic container 2 is separated from the induction coil 14 by the thermal insulation 16 which prevents heat generated in the bottom wall 8 of the container 2 to be transferred from the container 2 towards the induction coil 14 thereby reducing the overall effectivity of the heating process.

The current flowing in the induction coil 14 may be switched off after a predetermined period of time or after a predetermined temperature of the food received in the container 2 has been reached. After the heating process, the container 2 may be removed from the area of the induction coil 14 and the heated food may be served to a passenger.

In FIG. 2 a second embodiment of a container 2 according to the invention is shown. This embodiment mainly differs from the embodiment shown in FIG. 1 in that instead of electrically conductive fibers 10 embedded into the plastic a uniform layer or coating 18 of a metal as an electrically conductive material is used. Said layer 18 is located on the outer surface of the bottom wall 8 facing away from the inner surface which in use of the container 2 is in contact with food received in the container 2. In use, a magnetic field generated by the induction coil 14 generates eddy currents in the metal coating 18, the flow of these currents generating resistive heating inside the coating 18 thereby heating the bottom wall 8 and the food which is in contact with the same.

FIG. 3 shows a third embodiment of a plastic container according to the invention which combines the basic principles of providing the base body 4 with an electrically conductive material as shown in FIGS. 1 and 2. In particular, in the embodiment shown in FIG. 3, aluminum fibers 10 are embedded into the bottom wall 8 of the base body 4. In addition, a metal layer or coating 18 is located on a surface of the bottom wall 8 facing away from the inner surface which in use is in contact with the food to be heated. The combination of aluminum fibers 10 in combination with a metal layer or coating 18 allows for a very fast and economical heating of food received in the container 2.

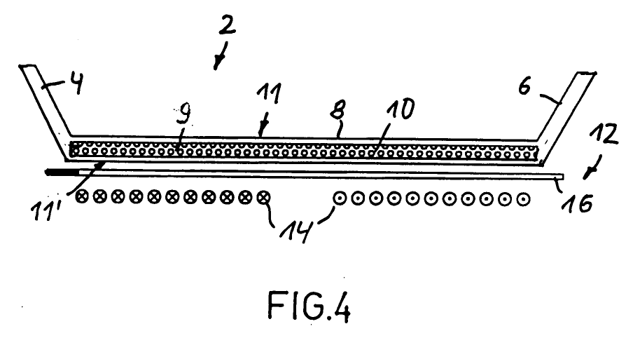

FIG. 4 shows a fourth embodiment of a container 2 according to the invention which differs from the embodiment shown in FIG. 1 in that in addition to the layer 11 of plastic covering the layer 9 of electrically conductive particles on its upper surface an additional layer 11′ of plastic is provided which covers the layer 9 on its lower surface. Thus, in the embodiment shown in FIG. 4 the layer 9 of electrically conductive particles 10 is completely embedded into the plastic.

While this invention has been described as having a preferred design, it is understood that it is capable of further modifications, and uses and/or adaptations of the invention and following in general the principle of the invention and including such departures from the present disclosure as come within the known or customary practice in the art to which the invention pertains, and as may be applied to the central features hereinbefore set forth, and fall within the scope of the invention or limits of the claims appended hereto.

1. A plastic container for food, comprising:
a) a base body, the base body being made of a material;
b) the material of the base body including a plastic;
c) electrically conductive particles being configured and embedded in the plastic for obtaining electrical conductivity of the material of the base body for induction-heating of food received in the container, in use.

2. Plastic container as claimed in claim 1, wherein:
a) the electrically conductive particles are provided in at least one of a side wall and a bottom wall of the base body.

3. Plastic container as claimed in claim 2, wherein:
a) the particles include fibers.

4. Plastic container as claimed in claim 1, wherein:
a) the particles include fibers.

5. Plastic container as claimed in claim 4, wherein:
a) the fibers include metal fibers.

6. Plastic container as claimed in claim 5, wherein:
a) the metal fibers include one of aluminum and silver.

7. Plastic container as claimed in claim 6, wherein:
a) the metal fibers include a material having a relatively low electrical conductivity which is coated with a material having a relatively high electrical conductivity.

8. Plastic container as claimed in claim 5, wherein:
a) the metal fibers include a material having a relatively low electrical conductivity which is coated with a material having a relatively high electrical conductivity.

9. Plastic container as claimed in claim 8, wherein:
a) the material having a relatively low electrical conductivity includes carbon.

10. Plastic container as claimed in claim 9, wherein:
a) in at least one electrically conductive section the particles embedded in the base body are in the form of a substantially uniform layer.

11. Plastic container as claimed in claim 3, wherein:
a) in at least one electrically conductive section the particles embedded in the base body are in the form of a substantially uniform layer.

12. Plastic container as claimed in claim 1, wherein:
a) in at least one electrically conductive section the particles embedded in the base body are in the form of a substantially uniform layer.

13. Plastic container as claimed in claim 3, wherein:
a) the particles have a size of approximately 1 to 10 μm.

14. Plastic container as claimed in claim 1, wherein:
a) the particles have a size of approximately 1 to 10 μm.

15. Plastic container as claimed in claim 12, wherein:
a) the substantially uniform layer is located on a surface of the container, and which surface is free of contact with food received in the container, in use.

16. Plastic container as claimed in claim 10, wherein:
a) the substantially uniform layer is located on a surface of the container, and which surface is free of contact with food received in the container, in use.

17. Plastic container as claimed in claim 1, wherein:
a) the plastic container for food includes one of injection molded and thermoformed plastic.

18. Use of plastic which is at least one of partially and sectionally electrically conductive for manufacturing a plastic container for food as in claim 1.

19. Use of plastic as claimed in claim 18, wherein:
a) the plastic container for food is manufactured by one of injection molding and thermoforming the plastic.
